(19) United States
(12) Patent Application Publication
(10) Pub. No.: US 2006/0007126 A1
(43) Pub. Date: Jan. 12, 2006

(54) WIRELESS PERIPHERAL AND RELATED CONTROL METHOD FOR SUPPORTING LEGACY KEYBOARD INPUTTING

(76) Inventor: Chien-Yi Shih, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,103

(22) Filed: Feb. 3, 2005

(30) Foreign Application Priority Data
Jun. 25, 2004 (TW) 093118604

(51) Int. Cl. G09G 5/00

(52) U.S. Cl. 345/156

(57) ABSTRACT

A wireless peripheral and control method for supporting legacy keyboard inputting. The wireless peripheral includes a wireless interface device (like a wireless keyboard) and a corresponding wireless receiving dongle. The dongle can be selectively connected to a wired input port (like a PS/2 port) or a universal connection port (like a USB port) of a host of the computer system, and the dongle has a firmware advanced control module for decoding signals of the wireless interface device to signals formatted for the wired input port. When the wireless peripheral is used for BIOS setting of the host, the dongle is connected to the wired input port, thus the advanced control module can be enabled to support a legacy input functionality of the computer system.

### BACKGROUND OF INVENTION

1. Field of the Invention

The present invention relates to a wireless peripheral and related control method, and more particularly, to a wireless peripheral and related control method for supporting legacy keyboard inputting.

2. Description of the Prior Art

A computer system is important hardware for modern information societies and a human interface device enables a user to conveniently control the computer system. Therefore, manufacturers have focused on developing the human interface device of the computer system, especially for wireless input devices. For instance, a Bluetooth wireless keyboard conforming to the Bluetooth protocol throws off the physical transmission line between the traditional keyboard and the computer system and makes it convenient for the user.

Generally, a wireless input interface device, such as a Bluetooth wireless keyboard, has to cooperate with a wireless dongle such as Bluetooth USB dongle, to establish a wireless input device. When the wireless input device is established, the Bluetooth USB dongle is connected to the USB port of the host of the computer system. When the user gives a command by pressing a key of the Bluetooth wireless keyboard, the command is transformed into a key signal by the Bluetooth wireless keyboard. Then the key signal is transformed (or packed) into a Bluetooth key signal conforming to the Bluetooth protocol and wirelessly transmitted to the Bluetooth USB dongle.

After the Bluetooth USB dongle receives the Bluetooth key signal from the Bluetooth wireless keyboard, the Bluetooth key signal is transformed into a USB command signal by a basic control module of firmware or hardware. The USB command signal is transmitted to the host through the USB port of the Bluetooth USB dongle and the USB port of the host. After the USB command signal is received from the Bluetooth USB dongle, the software operating system of the host will start a corresponding USB driver program to extract the Bluetooth key signal (i.e. key signal packed according to Bluetooth protocol). By cooperating with a corresponding Bluetooth driver program and an input interface program, such as an interface program supporting human interface device profile (HID profile) of Bluetooth protocol, the key signal can be extracted from the Bluetooth key signal. Then the host can operate according to the key signal and thereby achieve the purpose of controlling the host by the Bluetooth wireless keyboard.

As mentioned above, the key signal transmitted to the host must be transformed into the Bluetooth wireless signal, then transformed into the USB command signal, and finally extracted from the USB command signal to control the host. The USB driver program, the Bluetooth driver program, and the input interface program all steps. However, the programs can work only through coordination by the operating system. Hence, in the prior art, the software operating system of the host must be used to enable wireless input device to work correctly.

The prior art wireless input device can support basic input operations after the operating system is loaded. However, if the operating system is not yet loaded, the prior art wireless input device cannot support the basic input operations performed by the user. For example, when the user boots the computer, the basic input/output system (BIOS) setting is entered to set basic functions of the host, such as the operational clock of the host, detecting disk drives, setting voltages and IRQs, and etc. Therefore, an appropriate input device is used to perform the settings. However, while booting the computer, the operating system is not yet loaded and the wireless input device cannot operate. This is a drawback of the prior art wireless input device, not supporting the basic input operation if the operating system is not yet loaded.

### SUMMARY OF INVENTION

Therefore, the claimed invention provides a wireless peripheral and related control method for supporting legacy keyboard input to solve the above-mentioned problem. The claimed invention enables a user to execute the BIOS through the wireless peripheral when the operating system is not yet loaded.

The claimed invention comprises a wireless interface device and a wireless dongle. The dongle can be selectively connected to a wired input port (like a PS/2 port) or a universal connection port (like a USB port) of the host. The dongle comprises a basic control module for transforming a wireless key signal into a signal formatted for the universal connection port. In addition, the dongle further comprises a firmware advanced control module for extracting the key signal and transforming the key signal into a signal formatted for the wired input port.

Normally, the dongle is electrically connected to the universal connection port of the host. The wireless key signal from the wireless interface device is transformed into the signal formatted for the universal connection port by the basic control module and transmitted to the host by the universal connection port. The operating system of the host cooperates with driver programs of the universal connection port and the wireless peripheral. An input interface program extracts and analyzes the key signal so that the host can operate according to the key signal.

According to the claimed invention, when the operating system is not yet loaded, if the user wishes to execute a BIOS setting, the dongle is connected to the wired input port of the host through an adapter. The advanced control module of the dongle has functions similar to the wireless peripheral driver program and the input interface program to extract the key signal and transform the key signal into an input signal formatted for the wired input port. Finally, the input signal is transmitted to the host by the wired input port in order to support the basic input operations of the host.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a wireless peripheral of the present invention cooperating with a host in a computer system.

FIG. 2 shows the cooperation of the wireless peripheral and the host when the operating system is loaded.

FIG. 3 shows the cooperation of the wireless peripheral and the host when the operating system is not loaded.

### DETAILED DESCRIPTION

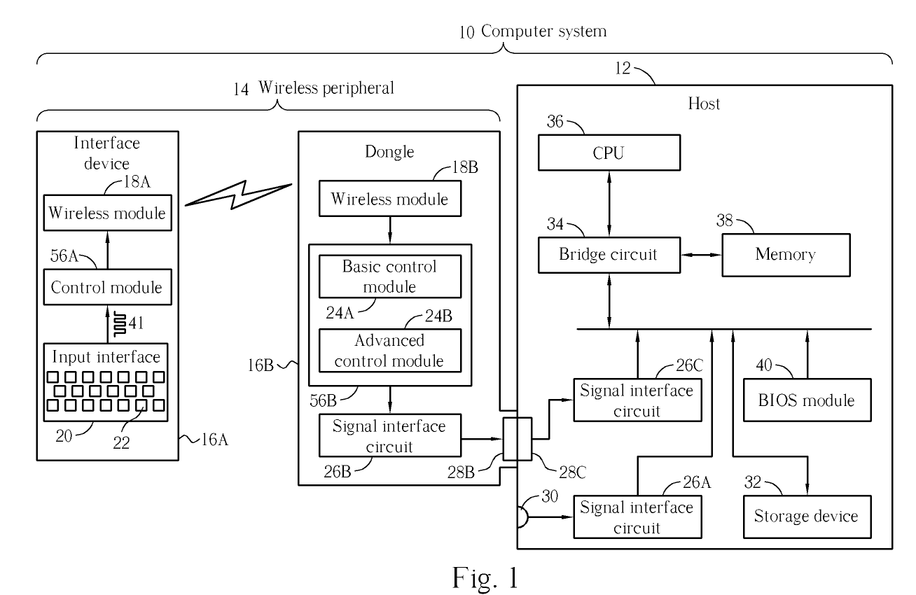

Please refer to FIG. 1, which is a diagram of a wireless peripheral 14 of the present invention cooperating with a host 12 in a computer system 1 0. The host 12 comprises a central process unit (CPU) 36, a bridge circuit 34 (such as chips of north bridge and/or south bridge circuits), a memory 38 (such as random access memory), a non-volatile storage device 32 (such as a hard disk or an optical disc drive), a basic input/output system (BIOS) module 40, and signal interface circuits 26A and 26C. The CPU 36 controls the operation of the host 12. The BIOS module 40 executes the BIOS of the host 12. The memory 38 temporarily stores data, information, and programs for the operation of the CPU 36. The storage device 32 stores information and programs for the operation of the host 12 in a non-volatile manner. In order to connect each peripheral, the host comprises at least a universal connection port 28C (like a USB port) and at least a wired input port 30 (like a PS/2 port). The signal interface circuit 26C receives signals conforming to the universal connection port 28C and the signal interface circuit 26A receives signals conforming to the wired input port 30. Signals or data can be transferred through the bridge circuit 34, the CPU 36, the memory 38, the storage device 32, and the signal interface circuit 26A and 26C.

The wireless peripheral of the present invention comprises a wireless interface device 16A and a corresponding wireless receiving dongle 16B. The interface device 16A comprises an input interface 20, a control module 56A, and a wireless module 18A. The input interface 20 can be a keyboard with a plurality of keys 22. When a user presses a key 22, the input interface 20 detects which key is pressed and generates a corresponding signal 41. The control module 56A controls the main operation of the interface device 16A and the wireless module 18A transforms electrical signals into wireless signals and then transmits wireless signals.

The dongle 16B comprises a wireless module 18B corresponding to the wireless module 18A, a control module 56B, and a signal interface circuit 26B. The wireless module 18B receives wireless signals from the wireless module 18A. The control module 56B, having a basic control module 24A and an advanced control module 24B, controls the operations of the dongle 16B, the modules 24A and 24B being implemented by firmware. In order to connect to the host 12, the dongle 16B comprises a universal connection port 28B corresponding to the universal connection port 28C of the host 12. The signal interface circuit 26B outputs electrical signals through the universal connection port 28B. The signal interface circuit 26B also can detect whether the universal connection port 28B is directly connected to another universal connection port (of a host, for example). If yes, the control module 56B will not start the advanced control module 24B meaning the advanced control module 24B is disabled.

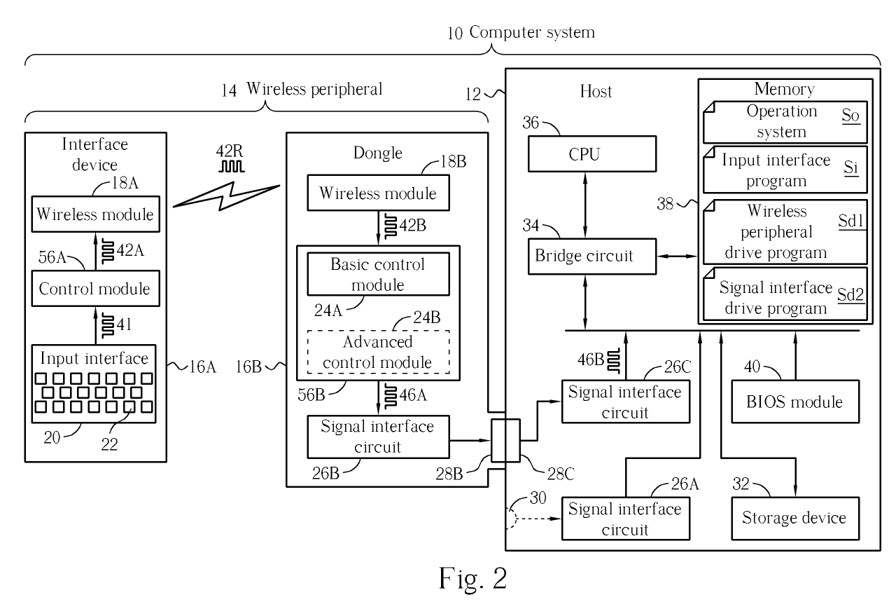

Please refer to FIG. 2, which shows the cooperation of the wireless peripheral 14 and the host 12. In FIG. 2, the computer system 10 performs a basic input operation after the operating system is loaded. After the host 12 completes the booting procedure, the CPU 36 loads a software operating system (like a Windows operating system) in the memory 38 so that the user can manage the host 12 under the operating system. When a basic input operation is performed under the operating system, the user can electrically connect the dongle 16B of the present invention to the universal connection port 28C. When the user inputs a command using the input interface 20, a key signal 41 is generated when the user presses a key 22. The control module 56A encodes the key signal 41 into a baseband key signal 42A according to a wireless communication protocol (such as a Bluetooth protocol). The wireless module 1 8A modulates the baseband key signal 42A into a wireless key signal 42R to output the wireless key signal 42R.

After the wireless module 18B of the dongle 16B receives the wireless key signal 42R, the wireless key signal 42R is transformed into a baseband key signal 42B by the wireless module 18B. Since the universal connection port 28B of the dongle 16B is electrically connected to the universal connection port 28C of the host 12, the control module 56B will not start the advanced control module 24B; instead, only the basic control module 24A is executed. The basic control module 24A transforms the key signal 42B into an indication signal 46A based on the signal format for the universal connection port 28B and thereby the indication signal 46A is transmitted into the host 12 through the signal interface circuit 26B and the universal connection ports 28B and 28C.

The host 12 receives the indication signal 46A from the dongle 16B through the universal connection port 28C and the signal interface circuit 26C. After the indication signal 46A is transformed into a indication signal 46B by the signal interface circuit 26C, the CPU 36 executes a signal interface driver program Sd2, a wireless peripheral driver program Sd1, and an input interface program Si through the operating system in order to extract the key signal from the indication signal 46B. The signal interface driver program Sd2 (such as a USB driver program) decodes the indication signal 46B to obtain related information according to the signal format of the universal connection ports 28B and 28C, the information corresponding to the baseband key signal 42B. The wireless peripheral driver program Sd1 (such as a Bluetooth driver program) further extracts the key signal corresponding to the key signal 41 from the information extracted by the signal interface driver program Sd2. Next, the input interface program Si (like a driver program for a Bluetooth human/computer interface) acquires the user's keystroke from the input interface 20 based on the key signal extracted by the wireless peripheral driver program Sd1 and thereby the CPU 36 can control the host 12 correctly.

In other words, after the operating system is loaded, if the user performs a basic input operation, the operating system also cooperates with the input interface program Si, the wireless peripheral driver program Sd1 and the signal interface driver program Sd2 so that the wireless peripheral 14 of the present invention can process the key signal transmitted from the wireless interface device 16A to the host 12.

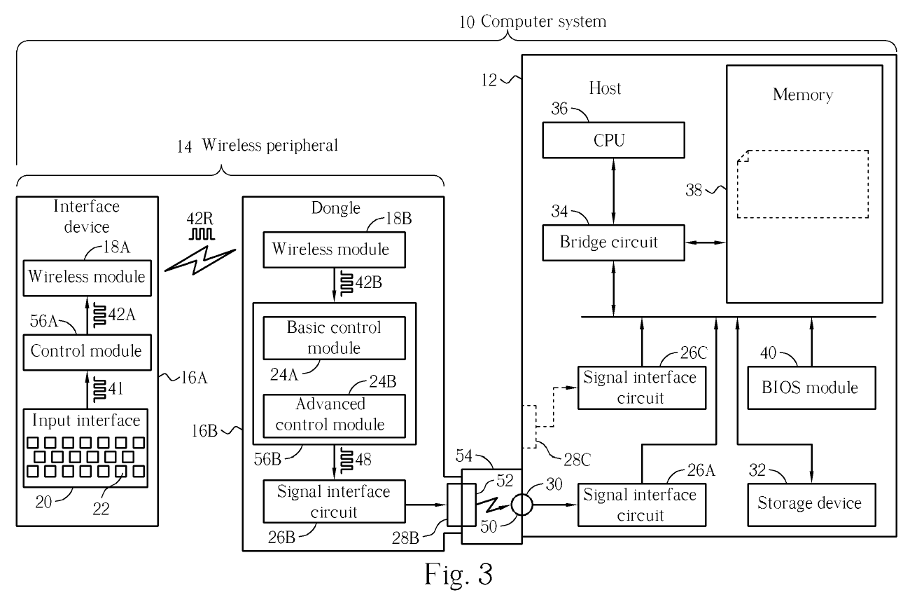

On the other hand, please refer to FIG. 3, which illustrates how the wireless peripheral 14 of the present invention supports the basic input operation when the operating system is not loaded. Before the operating system is loaded, if the user performs a legacy input operation through the wireless interface device 16A, an adapter 54 is used for electrically connecting the dongle 16B to the wired input port 30 of the host 12. Generally, when the operating system is not loaded, the host 12 still can receive a signal conforming to the format of a basic input signal from the input port 30 (like a PS/2 port). The present invention utilizes this property to support the basic input operation when the operating system is not loaded. For instance, when the host is booting, the wireless interface device 16A can support BIOS settings (i.e. legacy inputting) in the host.

As mentioned above, an adapter 54 is used for electrically connecting the dongle 16B to the host 12. The adapter 54 comprises a universal connection port 52 and a wired input port 50, respectively corresponding to the universal connection port 28B and the wired input port 30. The adapter 54 transmits the signal of the universal connection port 52 to the wired input port 50. The user connects the universal connection port 52 of the adapter 54 to the dongle 16B so that the dongle 16B can be electrically connected to the wired input port 30 of the host 12 through the wired input port 50 of the adapter 54. For instance, if the universal connection port is a USB port and the wired input port is a PS/2 port, the two terminals of differential signals D+ and D− of the USB port are electrically connected to the terminals of CLK and DATA of the PS/2 port, respectively.

From FIGS. 2 and 3, when the operating system is not loaded into the memory 38, the input interface program Si and the driver programs of FIG. 2 do not work. Therefore, the dongle 16B of the present invention can use the advanced control module 24B to transform the wireless key signal 42R of the interface device 16A into an input signal 48 formatted for the wired input port 30 and thereby support the legacy input operation of the host 12.

How the wireless peripheral 14 of the present invention supports the wireless basic input operations when the operating system is not loaded is described as follows. When the operating system is not loaded, if the user performs a wireless legacy input operation using the wireless peripheral 14 of the present invention, the dongle 16B is electrically connected to the host 12 through the adapter 54. After the connection is ready, the signal interface circuit 26B of the dongle 16B will detect whether the dongle 16B is electrically connected to the host 12 through the adapter 54, and the control module 56 enables the advanced control module 24B according to the detection result. When the user inputs a command by the input interface 20 of the interface device 16A, a key signal 41 is generated by the input interface 20, transformed into a baseband key signal 42A by the control module 56A, and then modulated into a wireless key signal 42R by the wireless module 18A.

The dongle 16B receives and decodes the wireless key signal 42R to a baseband key signal 42B and thereby the advanced control module 24B can extract the key signal from the baseband key signal 42B to analyze the command from the user. The control module 56 transforms the information resulting from the analysis by the advanced control module 24B into an input signal 48 formatted for the wired input port 30. Finally, the input signal 48 is transmitted into the host through the signal interface circuit 26B and the wired input ports 50 and 30. The host 12 still can directly receive the signal of the wired input port 30 as an input command when the operating system is not loaded and thereby the host 12 can perform corresponding operations according to the input signal 48. For instance, parameters for BIOS settings of the host 12 are set based on the input of the interface device 16A.

Another method of the present invention is to connect a host and a wireless peripheral, the host and the wireless peripheral being separate. The host comprises a wired input port, a universal connection port, and a BIOS module. The BIOS module receives a signal formatted for the wired input port to control the operations of the host. The wireless peripheral comprises an interface device and a dongle. The interface device is selectively electrically connected to the wired input port or the universal connection port through the dongle. The method comprises detecting the input of the wireless input device by the interface device to generate a corresponding key signal, wirelessly transmitting the key signal, the dongle receiving the key signal and providing a corresponding command signal according to the received key signal, and the dongle transmitting the command signal to the host. The command signal is transmitted to the host by the universal connection port of the host if the dongle is electrically connected to the universal connection port of the host. Otherwise, a corresponding input signal formatted for the wired input port is generated according to the command signal if the dongle is electrically connected to the wired input port of the host and the input signal is transmitted to the host through the wired input port.

Additionally, when the dongle is electrically connected to the universal connection port, the input signal formatted for the wired input port is not generated. When the dongle is electrically connected to the wired input port, the present invention uses the advanced control module to generate a corresponding input signal based on the command signal from the basic control module and thereby the input signal is transmitted to the host through the wired input port. When the dongle is electrically connected to the universal connection port, the advanced control module is disabled and the input signal formatted for the wired input port is not generated. Moreover, the present invention utilizes the signal interface circuit to detect whether the dongle is connected to the wired input port or the universal connection port.

As mentioned above, when the operating system is not loaded, the present invention can support the legacy input operation. The advanced control module 24B is substantially equivalent to the input interface program Si to extract the original key signal from the baseband key signal of the dongle 16. If the wireless peripheral 14 of the present invention is implemented with the Bluetooth protocol, the advanced control module 24B can support Human Interface Device Profile (HID Profile). However, the advanced control module 24B does not have to support all functions of the input interface program Si. Instead, the advanced control module 24B only has to support the basic input function and thereby the user can perform the legacy input operation when the operating system is not loaded.

In conclusion, whether the operating system is loaded or not, the wireless peripheral 14 of the present invention makes it convenient for the user to perform a wireless input operation using the wireless interface device. Generally, the user controls the host through the operating system after the operating system is loaded. In this case (in FIG. 2), the dongle 16B of the present invention automatically disables the advanced control module 24B if the dongle 16B is electrically connected to the universal connection port 28C of the host 12. The input interface program and the wireless peripheral program are executed by the operating system to cooperate with the wireless peripheral 14. It is easy to update and maintain the software input interface program and therefore, since the present invention operates with the input interface program in general conditions. The wireless peripheral 14 is updated with the input interface program and the flexibility of the wireless peripheral 14 is maintained.

If the user performs the legacy input operation when the operating system is not loaded, the user can connect the dongle 16 to the wired input port 28C of the host 12, as shown in FIG. 3. The dongle 16B therefore enables the advanced control module 24B so that the dongle 16 has the function of the input interface program. This enables the user to perform the basic input operation by using the wireless interface device 14A. For instance, the user changes the BIOS setting of the host through the wireless interface device 14A.

In the prior art, the wireless peripheral has to work with a software driver program. Hence, the prior art cannot support the basic input operation without the operating system loaded. Compared to the prior art, the wireless peripheral of the present invention can support the basic input operation through the wireless interface device when the operating system is not loaded. No matter what the condition is, the present invention enables the user to control the computer system by wireless.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless peripheral implemented with a host, the host comprising a wired input port, a universal connection port, and a BIOS module, the BIOS module receiving a signal formatted from the wired input port to control the operation of the host, the wireless peripheral comprising:
an interface device arranged in a wireless input device which is separated from the host, the interface device comprising:
an input interface for detecting a signal from the wireless input device and then generating a corresponding a key signal; and
a first wireless module for wirelessly transmitting the key signal; and
a dongle selectively connected to the wired input port or the universal connection port; the dongle comprising:
a second wireless module for wirelessly receiving the key signal;
a basic control module for providing a corresponding command signal based on the key signal received by the second wireless module, when the dongle is electrically connected to the universal connection port, the basic control module transmits the command signal to the host through the universal connection port; and
an advanced control module, when the dongle is electrically connected to the wired input port, the advanced control module generates a corresponding input signal formatted for the wired input port according to the command signal, the input signal being transmitted to the host through the wired input port.

2. The wireless peripheral of claim 1 wherein the dongle further comprising a signal interface circuit for detecting whether the dongle is connected to the wired input port or the universal connection port.

3. The wireless peripheral of claim 1 wherein the advanced control module is disabled and stops generating the input signal formatted for the wired input port when the dongle is electrically connected to the universal connection port.

4. A computer system comprising:
a host comprising a wired input port, a universal connection port, and a BIOS module, the BIOS module receiving a signal formatted for the wired input port to control the host;
a wireless peripheral comprising:
an interface device located in an wireless input device separate from the host, the interface device comprising:
an input interface for detecting a signal from the wireless input device and then generating a corresponding a key signal; and
a first wireless module for wirelessly transmitting the key signal; and
a dongle selectively electrically connected to the wired input port or the universal connection port; the dongle comprising:
a second wireless module for wirelessly receiving the key signal;
a basic control module for providing a corresponding command signal based on the key signal received by the second wireless module, when the dongle is electrically connected to the universal connection port, the basic control module transmits the command signal to the host through the universal connection port; and
an advanced control module, when the dongle is electrically connected to the wired input port, the advanced control module generates a corresponding input signal formatted for the wired input port according to the command signal, the input signal being transmitted to the host through the wired input port.

5. The computer system of claim 4 wherein the dongle further comprises a signal interface circuit for detecting that the dongle is connected to the wired input port or the universal connection port.

6. The computer system of claim 4 wherein the advanced control module is disabled and stops generating the input signal formatted for the wired input port when the dongle is electrically connected to the universal connection port.

7. A method for connecting a host and a separated wireless peripheral, the host comprising a wired input port, a universal connection port, and a BIOS module, the BIOS module receiving a signal formatted for the wire input port to control the host, the wireless peripheral comprising an interface device and a dongle, the interface device selectively electrically connected to the wired input port and the universal connection port through the dongle, the method comprising:
detecting the wireless input device by the interface device to generate a corresponding key signal, and then transmitting the key signal by wireless transmission;
receiving the key signal by the dongle and by wireless transmission, and then providing a corresponding command signal according to the received key signal; and
transmitting the command signal to the host through the dongle, wherein the available paths of transmitting the command signal comprises:
transmitting the command signal to the host through the universal connection port if the dongle is electrically connected to the universal connection port; and
generating a corresponding input signal formatted for the wired input port according to the command signal and transmitting the input signal to the host through the wired input port if the dongle is electrically connected to the wired input port.

8. The method of claim 7 further comprising stopping generating the input signal formatted for the wired input port if the dongle is electrically connected to the universal connection port.

9. The method of claim 7 further comprising an advanced control module for generating a corresponding input signal formatted for the wired input port according to the command signal provided by the basic control module if the dongle is electrically connected to the wired input port, the input signal being transmitted to the host through the wired input port.

10. The method of claim 9 further comprising disabling the advanced control module and stopping generating the input signal if the dongle is electrically connected to the universal connection port.

11. The method of claim 7 further comprising a signal interface circuit detecting that the dongle is connected to the wired input port or the universal connection port.

12. A wireless peripheral implemented with a host, the host comprising a wired input port and a BIOS module, the BIOS module receiving a signal formatted for the wired
input port to control the operation of the host, the wireless peripheral comprising:
an interface device arranged in a wireless input device, the interface device comprising:
an input interface for detecting a signal from the wireless input device to generate a corresponding key signal; and
a first wireless module for wirelessly transmitting the key signal; and
a dongle connected to the wired input port; the dongle comprising:
a second wireless module for wirelessly receiving the key signal;
a basic control module for providing a corresponding command signal based on the key signal received by the second wireless module; and
an advanced control module, when the dongle is electrically connected to the wired input port, the advanced control module generates a corresponding input signal formatted for the wired input port according to the command signal, the input signal being transmitted to the host through the wired input port.

13. The wireless peripheral of claim 12 wherein the dongle further comprising a signal interface circuit for detecting whether the dongle is connected to the wired input port.
